(19) United States
(12) Patent Application Publication
(10) Pub. No.: US 2025/0250966 A1
(43) Pub. Date: Aug. 7, 2025

(54) SYSTEM AND METHOD FOR REFURBISHING A WIND TURBINE

(71) Applicant: VINDMARK TECHNOLOGIES AB, Stockholm (SE)

(72) Inventors: Lars MATTILA, Stockholm (SE); Tomas LYRNER, Visby (SE)

(21) Appl. No.: 18/879,503

(22) PCT Filed: Jun. 26, 2023
(86) PCT No.: PCT/SE2023/050657

§ 371 Date: Dec. 27, 2024

(30) Foreign Application Priority Data
Jun. 28, 2022 (SE) 2250798-2

(51) Int. Cl. F03D 80/50; F03D 17/00

(52) U.S. Cl. CPC F03D 80/507; F03D 17/009; F05B 2230/80

(57) ABSTRACT

A system (100) for refurbishing an original wind turbine is provided. The system (100) comprises at least one processor (210) configured to: retrieve the average wind speed at the wind turbine site; determine suitable dimensions for a refurbished wind turbine (100) adapted for the wind turbine site; determine which parts of the original wind turbine that could be re-used and still obtain the determined dimensions for the refurbished wind turbine (100); for each part of the original wind turbine that could be re-used, calculate the expected remaining lifetime of said part; if said expected remaining lifetime is above a predetermined minimum lifetime, determine that said part can be re-used in the refurbished wind turbine (100); and select, from a database of replacement wind turbine parts, parts to use instead of the parts needing to be replaced for refurbishing the original wind turbine. Further, a method (400) for refurbishing an original wind turbine is provided.

### TECHNICAL FIELD

The present disclosure relates generally to a system and a method for refurbishing a wind turbine.

### BACKGROUND

A wind turbine is used to convert kinetic energy from wind into electrical power, and typically comprises a tower, and an energy-generating unit mounted at the top of the tower. The energy-generating unit typically comprises a rotor having a number of rotor blades extending from a central hub. As the wind causes the rotor blades to rotate, the energy-generating unit produces electrical power.

In order to achieve optimal efficiency in a wind turbine, the dimensions of the wind turbine should preferably be adapted to the wind turbine site. The height of a wind turbine (often referred to as hub height) affects the wind speed received by the energy-generating unit, since the wind speed is generally higher further from the ground. The diameter of the rotor (approximately twice the length of the rotor blades) affects the amount of wind that may be harvested by the energy-generating unit.

WO 2021/121505 describes a method of extending the life expectancy of a wind turbine by replacing an old generation energy-generating unit with a new generation energy-generating unit.

### Problems with the Prior Art

For different reasons, wind turbines are often not optimized for the locations in which they are operating. The efficiency of an existing wind turbine may be increased if the wind turbine would be adapted to the wind turbine site.

There is thus a need for a system and a method for enabling the adaptation of an existing wind turbine to the wind turbine site.

### SUMMARY

The above described problem is addressed by the claimed system for refurbishing an original wind turbine, installed at a wind turbine site and comprising at least one wind sensor. The system preferably comprises at least one processor and at least one storage device comprising a database of replacement wind turbine parts that could be used for refurbishing the original wind turbine. The at least one processor is preferably configured to: retrieve, from the at least one storage device, the average wind speed at the wind turbine site during the period of time in which the original wind turbine has been installed at the wind turbine site; determine suitable dimensions for a refurbished wind turbine adapted for the wind turbine site; determine which parts of the original wind turbine that could be re-used and still obtain the determined dimensions for the refurbished wind turbine, and which parts need to be replaced by replacement wind turbine parts; for each part of the original wind turbine that could be re-used, calculate the expected remaining lifetime of said part based on at least the average wind speed during the period of time in which the original wind turbine has been installed at the wind turbine site; if said expected remaining lifetime is above a predetermined minimum lifetime, determine that said part can be re-used in the refurbished wind turbine; and select, from the database comprised in the at least one storage device, replacement parts to use instead of the parts needing to be replaced for refurbishing the original wind turbine.

The above described problem is further addressed by the claimed method for refurbishing an original wind turbine, installed at a wind turbine site and comprising at least one wind sensor. The method preferably comprises: retrieving, from at least one storage device, the average wind speed at the wind turbine site during the period of time in which the original wind turbine has been installed at the wind turbine site; determining suitable dimensions for a refurbished wind turbine adapted for the wind turbine site; determining which parts of the original wind turbine that could be re-used and still obtain the determined dimensions for the refurbished wind turbine, and which parts need to be replaced by replacement wind turbine parts; for each part of the original wind turbine that could be re-used, calculating the expected remaining lifetime of the part based on at least the average wind speed during the period of time in which the original wind turbine has been installed at the wind turbine site; if said expected remaining lifetime is above a predetermined minimum lifetime, determining that the part can be re-used in the refurbished wind turbine; and selecting, from a database of replacement wind turbine parts that could be used for refurbishing the original wind turbine, replacement parts to use instead of the parts needing to be replaced for refurbishing the original wind turbine.

This enables the refurbishing of an existing wind turbine to adapt it to the wind turbine site, without the need to replace the entire wind turbine.

In embodiments, the average wind speed at the wind turbine site is determined based on measurements by the at least one wind sensor. However, the average wind speed at the wind turbine site may also be calculated from historical production values of the wind turbine or of neighboring wind turbines, or from general historical wind data for the wind turbine site taken from other sources.

In embodiments, the determining of suitable dimensions for the refurbished wind turbine involves determining whether it is the hub height or the rotor diameter that has the greatest effect on the efficiency of the refurbished wind turbine at the wind turbine site. This enables the optimization of the most important parameter, while still ensuring that the load on the tower will not become too high.

In embodiments, the determining of suitable dimensions for the refurbished wind turbine involves calculating the load on a lower section of the refurbished wind turbine, and dimensioning the refurbished wind turbine so that the load on said lower section of the refurbished wind turbine does not become higher than a threshold load. The threshold load may e.g. be determined based on the dimensions of the lower section of the refurbished wind turbine.

In embodiments, the dimensions for the refurbished wind turbine are dimensions for a refurbished wind turbine that would be optimized for the average wind speed at the wind turbine site.

In embodiments, the calculating of the expected remaining lifetime of each part of the original wind turbine that could be re-used is based also on data regarding the actual operation of the original wind turbine. Since the production of the wind turbine is continuously recorded, it can easily be determined how much the wind turbine has been operated during the period of time in which it has been installed at the wind turbine site.

In embodiments, the database comprises information regarding used wind turbine parts from other original wind turbines, where the expected remaining lifetime of each replacement wind turbine part has been calculated based on at least the average wind speed during the period of time in which the respective original wind turbine was installed at its wind turbine site, where the expected remaining lifetime of each replacement wind turbine part in said database is above the predetermined minimum lifetime. This enables the re-use of replacement parts from other wind turbines.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an embodiment of a wind turbine, in accordance with one or more embodiments described herein.

FIG. 2 schematically illustrates an embodiment of a system for refurbishing an original wind turbine, installed at a wind turbine site and comprising at least one wind sensor, in accordance with one or more embodiments described herein.

FIG. 3 shows a graph that illustrates equivalent loads in a critical point of a wind turbine at different wind speeds.

FIG. 4 schematically illustrates a method for refurbishing an original wind turbine, installed at a wind turbine site and comprising at least one wind sensor, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

In order to increase the efficiency of a wind turbine, the dimensions of the wind turbine should be adapted to the wind turbine site. The height of a wind turbine (often referred to as hub height) affects the wind speed received by the turbine, since the wind speed is generally higher further from the ground. The diameter of the rotor (approximately twice the length of the rotor blade) affects the amount of wind that may be harvested by the energy-generating unit. The efficiency of an existing wind turbine could be increased if the wind turbine would be adapted to the wind turbine site.

However, to replace a wind turbine is typically very costly, and since the lifetime of a wind turbine is typically very long, it would be advantageous to instead be able to refurbish an existing wind turbine with replacement parts. The refurbished wind turbine can in this way be adapted to the wind turbine site, regarding hub height and/or rotor diameter.

When refurbishing a wind turbine, there are often limitations to how high the hub height and how large the rotor diameter can be, since the lower parts of the original wind turbine need to be able to carry the load of the refurbished wind turbine. It is therefore often necessary to for each wind turbine site determine whether it is the hub height or the rotor diameter that has the greatest effect on the efficiency of the wind turbine. In some situations, e.g. where there are many trees affecting the wind, an increased hub height may increase the efficiency, even if the rotor diameter has to be decreased in order for the load on the tower not to become too high. In other situations, e.g. for ocean mounted wind turbines, the wind speed is not substantially higher at a higher hub height, and it may then be advantageous to instead decrease the hub height, in order to be able to use an energy-generating unit with a larger rotor diameter without the load on the tower becoming too high. This enables the optimization of the most important parameter, while still ensuring that the load on the tower will not become too high.

The present disclosure relates generally to a system and method for refurbishing a wind turbine. Embodiments of the disclosed solution are presented in more detail in connection with the figures.

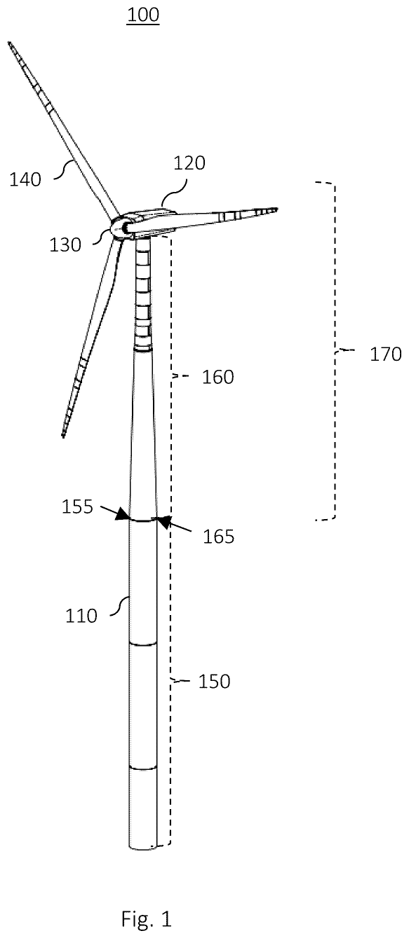

FIG. 1 illustrates an embodiment of a wind turbine 100. A wind turbine 100 typically comprises a tower 110, and an energy-generating unit 120, mounted at the top of the tower 110. The energy-generating unit 120 typically comprises a number of rotor blades 140 extending from a central hub 130. The energy-generating unit 120 illustrated in FIG. 1 comprises three rotor blades 140. As the wind causes the rotor blades 140 to rotate, the energy-generating unit 120 produces electrical power.

In order to adapt an existing wind turbine 100 to a wind turbine site, it is often advantageous to keep the lower section 150 of the wind turbine 100, but replace the entire top section 170 of the wind turbine 100, including the upper section 160 of the tower 110. In this way, the hub height and/or the rotor diameter can be adapted to the wind turbine site, without the need to replace the entire wind turbine 100. It is then important that the diameter of the lower end 165 of the upper section 160 of the tower 110 corresponds to the diameter of the upper end 155 of the lower section 150 of the tower 110. The new top section 170 of the wind turbine 100 may comprise new parts, and/or re-used parts from other wind turbines 100. If the new top section 170 of the wind turbine 100 comprises re-used parts taken from another wind turbine 100, the diameter of the lower end 165 of the upper section 160 of the tower 110 may need to be adapted in order to fit the upper end 155 of the lower section 150 of the tower 110. For all re-used parts, either in the new top section 170 of the wind turbine 100 or in the re-used lower tower section 150, it needs to be determined what their expected remaining lifetimes are.

When a new wind turbine 110 is designed, the design parameters are usually governed by the wind turbine class chosen for the design, in order for the wind turbine 110 to have a specified service life. The wind turbine class is typically based on the expected wind conditions at the site. The chosen wind turbine class is defined in codes, with reference to wind speed (including average wind speed) and turbulence intensity.

However, the actual average wind speed is often much lower than the expected average wind speed, which makes the actual lifetime much longer than the originally calculated lifetime, especially since there is an exponential relationship between the average wind speed and the lifetime. If the actual average wind speed is 50% lower than the expected average wind speed, the expected lifetime may be more than four times longer than the originally calculated lifetime.

If a wind turbine 110 is originally expected to have a lifetime of 25 years, and a refurbishing is made after 15 years, it could be expected that the re-used parts would have a remaining lifetime of 10 years. However, since the wind conditions are continuously monitored when a wind turbine 110 is operated, it is possible to calculate a new remaining lifetime based on the actual average wind speed. The average wind speed may be determined based on measurements by a wind sensor 230 in the wind turbine 110, but it may also be calculated from historical production values of the wind turbine 110, or of neighboring wind turbines 110, or from general historical wind data for the wind turbine site taken from other sources.

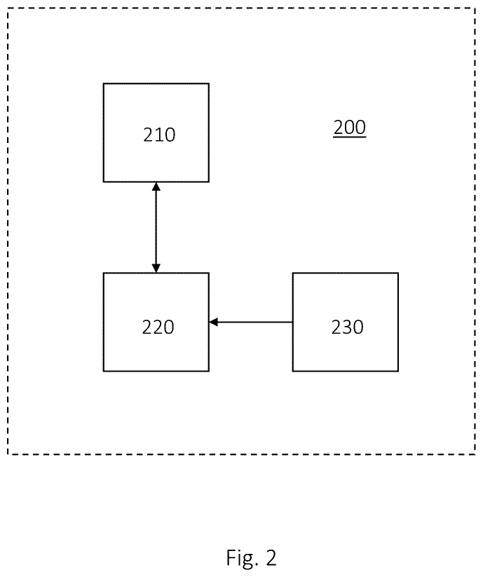

FIG. 2 schematically illustrates an embodiment of a system 200 for refurbishing an original wind turbine, installed at a wind turbine site and comprising at least one wind sensor 230. The system 200 comprises at least one processor 210 and at least one storage device 220 comprising a database of replacement wind turbine parts that could be used for refurbishing the original wind turbine. The at least one processor 210 may be configured to retrieve the average wind speed during the period of time in which the original wind turbine has been installed at the wind turbine site from the at least one storage device 220. The average wind speed at the wind turbine site may e.g. be determined based on measurements by the at least one wind sensor 230, but it may also be calculated from historical production values of the wind turbine 110, or of neighboring wind turbines 110, or from general historical wind data for the wind turbine site taken from other sources. The at least one processor 210 is preferably configured to determine suitable dimensions for a refurbished wind turbine 100 adapted for the wind turbine site.

In embodiments, the determining of the dimensions for the refurbished wind turbine 100 involves determining whether it is the hub height or the rotor diameter that has the greatest effect on the efficiency of the refurbished wind turbine 100 at the wind turbine site. This enables the optimization of the most important parameter, while still ensuring that the load on the tower 110 will not become too high. In some situations, e.g. where there are many trees affecting the wind, an increased hub height may increase the efficiency, even if the rotor diameter has to be decreased in order for the load on the tower 110 not to become too high.

In other situations, e.g. for ocean mounted wind turbine 100, the wind speed is not substantially higher at a higher hub height, and it may then be advantageous to instead decrease the hub height, in order to be able to use an energy-generating unit 120 with a larger rotor diameter without the load on the tower 110 becoming too high.

Since it is a much more efficient use of resources to re-use as much as possible of the original wind turbine, instead of entirely replacing it, the next step is preferably for the at least one processor 210 to determine which parts of the original wind turbine that could be re-used and still obtain the determined dimensions for the refurbished wind turbine 100. If the refurbished wind turbine 100 should have different lengths of the rotor blades 140 than the energy-generating unit 120 of the original wind turbine, it is typically necessary to replace the entire energy-generating unit 120. If the refurbished wind turbine 100 should have a different hub height than the tower 110 of the original wind turbine, then the lower tower section 150 could still be re-used, but a new tower section 160 needs to be added. This tower section 160 could be a re-used tower section 160 taken from another wind turbine 100, and it may already be adapted and connected to an energy-generating unit 120 from the other wind turbine 100, to form a new top section 170. If the new top section 170 intended to be used for refurbishing the wind turbine 100 comprises re-used parts taken from another wind turbine 100, the diameter of the lower end 165 of the upper section 160 of the tower 110 may need to be adapted in order to fit the upper end 155 of the lower tower section 150. If a custom-made new top section 170 is manufactured, this is preferably designed to fit the upper end 155 of the lower tower section 150.

In order to determine whether all desired parts of the wind turbine can be re-used, it is necessary for the at least one processor 210 to determine the expected remaining lifetime of each part based on the average wind speed during the period of time in which the original wind turbine has been installed at the wind turbine site. As explained above, the actual average wind speed is often much lower than the expected average wind speed, which makes the actual lifetime much longer than the originally calculated lifetime, especially since there is an exponential relationship between the average wind speed and the lifetime. If the actual average wind speed is 50% lower than the expected average wind speed, the expected lifetime may be more than four times longer than the originally calculated lifetime.

In embodiments, the determining of suitable dimensions for the refurbished wind turbine 100 involves calculating the load on a lower section 150 of the refurbished wind turbine 100, and dimensioning the refurbished wind turbine 100 so that the load on said lower section 150 of the refurbished wind turbine 100 does not become higher than a threshold load. The threshold load may be determined based on the dimensions of the lower section 150 of the refurbished wind turbine 100, or by determining an equivalent load M_{eq} at a critical point of the wind turbine 100, expressed as

$${M}_{{eq}_{threshold}} = {( {( {M}_{{eq}_{Vdesian}} )}^{m} - {( {M}_{{eq}_{Vactual}} )}^{m} )}^{\frac{1}{m}}$$

where V_{actual} and V_{design} is the actual average wind speed at the wind turbine site and the originally expected average wind speed respectively, while m stands for the slope exponent of the SN-curve.

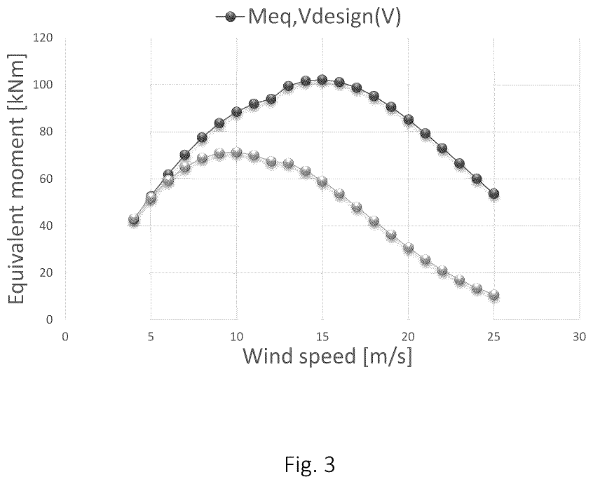

FIG. 3 shows a graph that illustrates equivalent loads in a critical point of a wind turbine at different wind speeds. The upper curve illustrates the equivalent load in the critical point of the wind turbine according to the wind turbine class parameters, which represent the expected average wind speed. The lower curve illustrates the equivalent load in the critical point of the wind turbine with an actual, lower, average wind speed.

The expected remaining lifetime is typically calculated based primarily on the fatigue of the materials in the wind turbine, especially various attachment components such as welds and/or bolts. The calculations may involve simulating the loads on the wind turbine based on the wind conditions during the period of time in which the original wind turbine has been installed at the wind turbine site. Such simulations may also use information regarding how the wind turbine has actually been operating, including parameters such as e.g. the pitch of the rotor blades.

As explained above, each part of a wind turbine has a defined service life and defined design parameters, which are usually governed by the wind turbine class chosen for the design of the wind turbine. The chosen wind turbine class is defined in codes, with reference to wind speed (including average wind speed) and turbulence intensity. In order to calculate the expected remaining lifetime, the wind turbine class and the originally defined lifetime of the original wind turbine should preferably first be obtained.

The expected remaining lifetime of the parts of the original wind turbine may be expressed as

$$Remaining life = Design life {( 1 - \frac{{M}_{{eq}_{Vactual}}}{{M}_{{eq}_{Vdesign}}} )}^{\frac{1}{m}}$$

M_{eq} can be expressed as

$${M}_{eq} = {( \frac{1}{{N}_{eq}} ( {\sum }_{i}^{l} {n}_{i} {{M}_{i} ( P ( V ) )}^{m} ) )}^{\frac{1}{m}}$$

where N_{eq} is the equivalent number of load cycles, normally 10⁷, and Mᵢ is the load at a certain wind speed that occurs with nᵢ load cycles.
P(V) is the Rayleigh wind distribution and can be expressed as

$$P ( V ) = {P}_{R} ( {V}_{hub} ) = 1 - exp [ - {π ( \frac{{V}_{hub}}{2 {V}_{design}} )}^{2} ]$$

where P(V) is the probability function for an actual wind speed V_{hub} at the hub height.

The expected remaining lifetime may alternatively be calculated based on measurements of the actual present dimensions of various parts of the wind turbine, using e.g. laser and ultrasound to determine how the various parts of the wind turbine have been affected by the loads over time.

In embodiments, the expected remaining lifetime of each part of the original wind turbine that could be re-used is calculated based also on data regarding the actual operation of the original wind turbine. Since the production of the wind turbine is continuously recorded, it can easily be determined how much the wind turbine has been operated during the period of time in which it has been installed at the wind turbine site.

If the calculated expected remaining lifetime is above a predetermined minimum lifetime, the at least one processor 210 preferably determines that the part can be re-used in the refurbished wind turbine 100. The predetermined minimum lifetime is a threshold than may depend on many factors, but typically needs to be at least ten years for refurbishing to be worthwhile.

When the at least one processor 210 has determined which parts of the original wind turbine that could be re-used, it follows from this that all other parts need to be replaced by replacement wind turbine parts for refurbishing the original wind turbine. The at least one processor 210 preferably selects such replacement wind turbine parts from a database comprised in the at least one storage device 220, which database comprises information regarding replacement wind turbine parts that could be used for refurbishing the original wind turbine. The database could comprise information regarding new replacement wind turbine parts as well as information regarding used replacement wind turbine parts, which are available for re-use. The parts may be available in storage, available to be ordered from a manufacturer, or still be used in operating wind turbines. In some situations, it may be an efficient use of resources to shift a number of top sections 170 between different operating wind turbines.

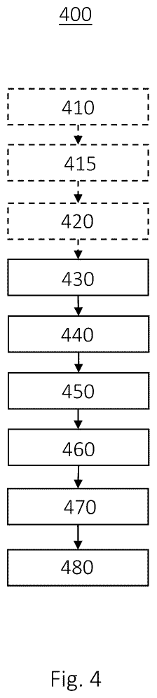

FIG. 4 schematically illustrates a method for refurbishing an original wind turbine, installed at a wind turbine site and comprising at least one wind sensor 230. The method 400 may comprise:

Step 430: retrieving, from at least one storage device 220, the average wind speed at the wind turbine site during the period of time in which the original wind turbine has been installed at the wind turbine site.

Step 440: determining suitable dimensions for a refurbished wind turbine 100 adapted for the wind turbine site.

Step 450: determining which parts of the original wind turbine that could be re-used and still obtain the determined dimensions for the refurbished wind turbine 100, and which parts need to be replaced by replacement wind turbine parts 170.

Step 460: calculating, for each part of the original wind turbine that could be re-used, the expected remaining lifetime of the part based on at least the average wind speed during the period of time in which the original wind turbine has been installed at the wind turbine site.

Step 470: determining, if said expected remaining lifetime is above a predetermined minimum lifetime, that the part can be re-used in the refurbished wind turbine 100.

Step 480: selecting, from a database of replacement wind turbine parts that could be used for refurbishing the original wind turbine, replacement parts to use instead of the parts needing to be replaced for refurbishing the original wind turbine.

This enables the refurbishing of an existing wind turbine to adapt it to the wind turbine site, without the need to replace the entire wind turbine. The various steps of the method 400 may be conducted in any order that makes technical sense, and some of them may be conducted simultaneously.

In embodiments, the determining 440 of suitable dimensions for a refurbished wind turbine 100 involves determining whether it is the hub height or the rotor diameter that has the greatest effect on the efficiency of the refurbished wind turbine 100 at the wind turbine site. This enables the optimization of the most important parameter, while still ensuring that the load on the tower 110 will not become too high.

In embodiments, the determining 440 of suitable dimensions for a refurbished wind turbine 100 involves calculating the load on a lower section 150 of the refurbished wind turbine 100, and dimensioning the refurbished wind turbine 100 so that the load on said lower section 150 of the refurbished wind turbine 100 does not become higher than a threshold load. The threshold load may e.g. be determined based on the dimensions of the lower section 150 of the refurbished wind turbine 100.

In embodiments, the determining 440 of suitable dimensions for a refurbished wind turbine 100 involves determining dimensions for a refurbished wind turbine 100 that would be optimized for the average wind speed at the wind turbine site.

In embodiments, the calculating 460 of the expected remaining lifetime of each part of the original wind turbine that could be re-used is based also on data regarding the actual operation of the original wind turbine. Since the production of the wind turbine 100 is continuously recorded, it can easily be determined how much the wind turbine 100 has been operated during the period of time in which it has been installed at the wind turbine site.

The method 400 may further comprise one or more of: Step 410: determining the average wind speed at the wind turbine site by continuously measuring the wind conditions using the at least one wind sensor 230. However, the average wind speed at the wind turbine site may also be calculated from historical production values of the wind turbine, or of neighboring wind turbines, or from general historical data for the wind turbine site taken from other sources.

Step 415: storing the measurements in the at least one storage device 220.

Step 420: arranging the database to comprise information regarding used wind turbine parts from other original wind turbines 100, where the expected remaining lifetime of each replacement wind turbine part has been calculated based on at least the average wind speed during the period of time in which the respective wind turbine 100 was installed at its wind turbine site. The expected remaining lifetime of each replacement wind turbine part in said database is preferably above the predetermined minimum lifetime. This enables the re-use of replacement parts from other wind turbines.

These optional steps may be conducted in any order that makes technical sense. For example, step 420 could be conducted before any of the other steps of the method 400.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. A system for refurbishing an original wind turbine, installed at a wind turbine site and comprising at least one wind sensor, the system comprising at least one processor and at least one storage device comprising a database of replacement wind turbine parts that could be used for refurbishing the original wind turbine, wherein the at least one processor is configured to:
retrieve, from the at least one storage device, the average wind speed at the wind turbine site during the period of time in which the original wind turbine has been installed at the wind turbine site;
determine suitable dimensions for a refurbished wind turbine adapted for the wind turbine site, wherein the dimensions for the refurbished wind turbine are dimensions for a refurbished wind turbine that would be optimized for the average wind speed at the wind turbine site, and the determining of suitable dimensions for the refurbished wind turbine involves determining whether it is the hub height or the rotor diameter that has the greatest effect on the efficiency of the refurbished wind turbine at the wind turbine site;
determine which parts of the original wind turbine that could be re-used and still obtain the determined dimensions for the refurbished wind turbine (100), and which parts need to be replaced by replacement wind turbine parts (170);
for each part of the original wind turbine that could be re-used, calculate the expected remaining lifetime of said part based on at least the average wind speed at the wind turbine site during the period of time in which the original wind turbine has been installed at the wind turbine site;
if said expected remaining lifetime is above a predetermined minimum lifetime, determine that said part can be re-used in the refurbished wind turbine; and
select, from the database comprised in the at least one storage device, replacement parts to use instead of the parts needing to be replaced for refurbishing the original wind turbine.

2. The system according to claim 1, wherein the at least one processor is configured to determine the average wind speed at the wind turbine site based on measurements by the at least one wind sensor.

3. (canceled)

4. The system according to claim 1, wherein the determining of suitable dimensions for the refurbished wind turbine involves calculating the load on a lower section of the refurbished wind turbine, and dimensioning the refurbished wind turbine so that the load on said lower section of the refurbished wind turbine does not become higher than a threshold load.

5. (canceled)

6. The system according to claim 1 any one of claims 1-5, wherein the expected remaining lifetime of each part of the original wind turbine that could be re-used is calculated based also on data regarding the actual operation of the original wind turbine.

7. The system according to claim 1, wherein said database in the at least one storage device comprises information regarding used wind turbine parts from other original wind turbines, where the expected remaining lifetime of each replacement wind turbine part has been calculated based on at least the average wind speed during the period of time in which the respective original wind turbine was installed at its wind turbine site, where the expected remaining lifetime of each replacement wind turbine part in said database is above the predetermined minimum lifetime.

8. A method for refurbishing an original wind turbine, installed at a wind turbine site and comprising at least one wind sensor, the method comprising:
retrieving, from at least one storage device, the average wind speed at the wind turbine site during the period of time in which the original wind turbine has been installed at the wind turbine site;
determining suitable dimensions for a refurbished wind turbine adapted for the wind turbine site, wherein the determining of suitable dimensions for a refurbished wind turbine involves determining dimensions for a refurbished wind turbine that would be optimized for the average wind speed at the wind turbine site, and wherein the determining of suitable dimensions for a refurbished wind turbine involves determining whether it is the hub height or the rotor diameter that has the greatest effect on the efficiency of the refurbished wind turbine at the wind turbine site;
determining which parts of the original wind turbine that could be re-used and still obtain the determined dimensions for the refurbished wind turbine, and which parts need to be replaced by replacement wind turbine parts;
calculating, for each part of the original wind turbine that could be re-used, the expected remaining lifetime of the part based on at least the average wind speed during the period of time in which the original wind turbine has been installed at the wind turbine site;
determining, if said expected remaining lifetime is above a predetermined minimum lifetime, that the part can be re-used in the refurbished wind turbine; and
selecting, from a database of replacement wind turbine parts that could be used for refurbishing the original wind turbine, replacement parts to use instead of the parts needing to be replaced for refurbishing the original wind turbine.

9. The method according to claim 8, further comprising determining the average wind speed at the wind turbine site by continuously measuring the wind conditions using the at least one wind sensor, and storing the measurements in the at least one storage device.

10. (canceled)

11. The method according to claim 8, wherein the determining of suitable dimensions for a refurbished wind turbine involves calculating the load on a lower section of the refurbished wind turbine, and dimensioning the refurbished wind turbine so that the load on said lower section of the refurbished wind turbine does not become higher than a threshold load.

12. (canceled)

13. The method according to claim 8, wherein the calculating of the expected remaining lifetime of each part of the original wind turbine that could be re-used is based also on data regarding the actual operation of the original wind turbine.

14. The method according to claim 8, further comprising arranging said database to comprise information regarding used wind turbine parts from other original wind turbines, where the expected remaining lifetime of each replacement wind turbine part has been calculated based on at least the average wind speed during the period of time in which the respective original wind turbine was installed at its wind turbine site, and where the expected remaining lifetime of each replacement wind turbine part in said database is above the predetermined minimum lifetime.
